(19) United States
(12) Patent Application Publication
(10) Pub. No.: US 2025/0229476 A1
(43) Pub. Date: Jul. 17, 2025

(54) APPARATUS AND METHOD FOR PRODUCING PLASTICS MATERIAL PREFORMS WITH SPECTRAL ANALYSIS DEVICE

(71) Applicant: KRONES AG, Neutraubling (DE)

(72) Inventor: Andreas MEYER, Parkstetten (DE)

(21) Appl. No.: 19/022,028

(22) Filed: Jan. 15, 2025

(30) Foreign Application Priority Data
Jan. 15, 2024 (DE) 10 2024 101 050.9

(51) Int. Cl. B29C 49/78; B29C 49/06

(52) U.S. Cl. CPC B29C 49/78; B29C 49/06; B29C 2049/7876

(57) ABSTRACT

An apparatus for producing plastics material containers has a production device having a plurality of production units for producing plastics material preforms, a forming device having a plurality of forming stations for forming the plastics material preforms into the plastics material containers and a transport device for transporting the plastics material preforms produced by the production device to the forming device. The apparatus has a spectral analysis device for inspecting and/or analyzing at least one area of the plastics material preforms produced by the production device, arranged between the production device and the forming device. The spectral analysis device is configured for spectral analysis of the radiation impinging thereon.

### BACKGROUND OF THE INVENTION

The present invention relates to an apparatus and a method for producing plastics material containers and, in particular, plastics material bottles. Numerous apparatuses and methods of this kind are known from the prior art.

Typically, so-called plastics material preforms are heated and formed and in particular expanded into the plastics material containers by a forming device such as a blow molding machine, in particular a stretch blow molding machine. In recent times, apparatuses and methods have also become known in which the plastics material preforms themselves are produced, for example by injection molding machines, and then formed.

This can offer the advantage that less heating of the plastics material preforms is required in order to expand them, because they come out of the production process already heated. However, apparatuses and methods of this kind require more precise monitoring of the plastics material preforms, so that fewer errors and less waste occur during the production of the plastics material containers.

DE 10 2008 019 176 A1 discloses a method and an apparatus for the production of plastics material containers with infrared absorption monitoring. Conclusions about the quality of the plastics material preforms can be drawn from this analysis.

DE 10 2020 123166 A1 describes an apparatus and method for heating plastics material preforms with spatially resolved temperature detection. DE 10 2021 107 545 A1 discloses a method and an apparatus for analyzing plastics material preforms.

The present invention is based on the object of improving the automation and/or error processing of systems of this kind. In addition, the control options for the individual machines in such systems are also to be improved.

### SUMMARY OF THE INVENTION

An apparatus according to the invention for producing plastics material containers has a production device which is suitable and intended for producing plastics material preforms, and a forming device which is suitable and intended for forming the plastics material preforms (and in particular the plastics material preforms produced by the production device) into the plastics material containers, wherein the production device has a plurality of production units for producing the plastics material preforms and the forming device has a plurality of forming stations for forming the plastics material preforms into the plastics material containers and furthermore a transport device is provided which is suitable and intended for transporting the plastics material preforms produced by the production device to the forming device.

According to the invention, the apparatus has a first spectral analysis device which is suitable and intended for inspecting and/or (in particular spectrally) analyzing at least one area of the plastics material preforms produced by the production device, wherein this first spectral analysis device is arranged between the production device and the forming device, and wherein this first spectral analysis device is suitable and intended for spectrally analyzing the radiation impinging on it.

In a further preferred embodiment, the apparatus has a first inspection device which is suitable and intended for inspecting at least one area of the plastics material preforms produced by the production device.

In a preferred embodiment, the inspection device has an image recording device which is suitable and intended for recording at least one spatially resolved image of a plurality of plastics material preforms.

Preferably, an inspection device is understood to be an inspection device which is suitable and intended for inspecting the plastics material preforms after they have been produced. For this purpose, a carrier can be provided, which supports a plurality of plastics material preforms (immediately) after their production, so that the image recording device can record an image of the plastics material preforms held or supported by the carrier (in particular of at least one region of these plastics material preforms).

Preferably, the first inspection device is integrated into the production device.

In a further preferred embodiment, the inspection device is configured in such a way that it has or makes possible a mouth inspection of the plastics material preforms directly at a removal device, which removes the produced plastics material preforms from the production device.

In a preferred embodiment, the transport device has a removal device that is suitable and intended for picking up groups of produced plastics material preforms from the production device.

In a further preferred embodiment, the transport device has a movable carrier that is configured to hold a plurality of plastics material preforms.

Preferably, the first region of the plastics material preforms is a mouth region of the plastics material preforms. Preferably, the mouth region has a thread and in particular an external thread.

In a further preferred embodiment, the forming device has a movable and in particular a rotatable carrier, wherein the forming stations are preferably arranged on this carrier. Particularly preferably, each forming station has a blow mold and preferably each of these forming stations has a rod-like body and in particular a so-called stretching rod, which can be inserted into these plastics material preforms for stretching the plastics material preforms.

In the further preferred embodiments, each forming station has an application device for applying a gaseous medium to the plastics material preforms and preferably also has a valve arrangement such as a valve block. This valve arrangement preferably has a plurality of valves that control the pressure application of the plastics material preforms. The application device preferably has a so-called blowing nozzle, which can be placed against a mouth of the plastics material preforms.

Particularly preferably, the production device is an injection molding machine. Particularly preferably, this injection molding machine has at least 10, preferably at least 20 and particularly preferably at least production units.

Particularly preferably, the production device and in particular the injection molding machine has a maximum of 200, preferably a maximum of 180, preferably a maximum of 160 production units.

It is possible that the production units are arranged on a common carrier. Preferably, each of these production units is suitable and intended for producing exactly one plastics material preform. Preferably, the production units are in each case mold tools.

In a further preferred embodiment, the production units in each case have marking devices that are suitable and intended for applying markings to the plastics material preforms to be produced, wherein these markings are preferably characteristic at least of the particular production unit.

In a further preferred embodiment, the spectral analysis device is suitable and intended for detecting predetermined spectral areas or wavelength ranges of the radiation, wherein preferably the wavelength ranges are selected from a group of spectral areas comprising a UV radiation area, a visible radiation area, a near-infrared radiation area, a short-wave infrared radiation area and the like.

In a preferred embodiment, the spectral analysis unit has at least one sensor unit which is suitable and intended for detecting a specific wavelength range. In a preferred one, the spectral analysis unit has at least two and preferably several sensor units which are suitable and intended for detecting several different wavelength ranges of the radiation incident on them.

This spectral analysis can preferably be used to detect contamination of the plastics material preforms, for example by plastics other than PET or by other impurities that are present in the plastics material, for example in the plastics flakes, as a result of recycling solutions.

This spectral analysis can also be used to detect moisture. For example, the proportion of water in the plastics material can be detected.

Preferably, the spectral analysis device is designed in such a manner that it analyzes at least one area of the main body of the plastics material preforms. These areas are particularly relevant as they are formed by the forming device.

In a preferred embodiment, various sensor units, in particular UV sensor units, sensor units for the visible wavelength range, sensor units for the near infrared range (NIR), sensor units for the SWIR (short wave infrared) and the like are present.

In a further advantageous embodiment, the spectral analysis unit has a light source and/or radiation source and a detector device. Preferably, the plastics material preforms can be transported between this radiation source and the detector device. Alternatively or additionally, the light source and/or radiation source can also be embodied as a module.

In a further preferred embodiment, the spectral analysis device has a radiation device which irradiates the plastics material preforms and a radiation detector device which is suitable and intended for detecting radiation emitted by the radiation device and passing through the plastics material preforms. Preferably, the plastics material preforms and in particular their main bodies are transported between this radiation device and the radiation detector device.

In a preferred embodiment, the spectral analysis unit is suitable and intended to perform measurements in a transmitted light method.

Preferably, the spectral analysis unit is suitable and intended for determining a moisture content of the plastics material preforms.

Furthermore, an inspection device for inspecting the formed containers is preferably provided. It is possible that formed and in particular blow-molded containers are inspected spectrally and/or conventionally in order to provide feedback on the results of the spectral analysis. For example, it can be trained up to which soot content in a plastics material preform perfect containers can be formed and can be sorted out accordingly in advance.

In a further preferred embodiment, the spectral analysis device is a spectral analysis device which is suitable and intended for the receptacle of several spectra and in particular several spectra in different wavelength ranges.

Corresponding sensor devices for different wavelength ranges are known from the prior art.

In a further preferred embodiment, the apparatus has a second spectral analysis device suitable and intended for inspecting at least one area of the plastics material containers produced by the forming device. In this manner, the control and/or regulation of the production device and/or the forming device can be further improved.

In a further preferred embodiment, the apparatus has a further spectral analysis device which is suitable and intended for inspecting at least one area of the plastics material containers produced by the production device. In this manner, the control and/or regulation of the production device and/or the forming device can be further improved. Preferably, the first and second spectral analysis devices are arranged at different positions along the transport path of the plastics material preforms.

In a further preferred embodiment, at least one spectral analysis device is arranged between the production device and a further heating device for heating the plastics material preforms. In a further preferred embodiment, at least one spectral analysis device is arranged between a further heating device for heating the plastics material preforms and the forming device.

In a further preferred embodiment, the apparatus has a memory device in which a plurality of spectral data characteristic of the plastics material preforms is stored. For example, spectral analyses can be stored for different plastics preforms, for example for plastics preforms made from a specific plastic, plastics preforms made with a specific recycling content of the plastic, plastics preforms molded using a specific injection molding machine and the like.

Preferably, a comparison device is provided which compares this spectral data with data detected by the at least one spectral analysis device. In this manner, certain types of plastics material preforms can be identified. Based on this identification, the production device and/or the forming device can be controlled and/or regulated.

Spectral data can be compared to identify specific plastics material preforms, or a recipe for controlling the production device and/or the forming device can be selected based on this comparison. For example, specific recipes for the production or forming of different plastics material preforms may be available.

If a specific plastics material preform is now analyzed, it can be checked whether it corresponds to an already known plastics material preform. If this is the case, a certain recipe can be adjusted for its forming (about certain blowing pressures, a certain movement of the stretching rods or times at which certain blowing pressures are applied). Parameters of a heating device can also be adjusted, about the heat output of certain radiant heaters of the heating device.

Artificial intelligence (AI) can be used for control and/or regulation and/or evaluation of spectra during the matching or comparison.

For example, it is possible for a comparison to be made with a database or with data stored in a database. The data stored in the database may be reference values, in particular reference values for specific preforms. An Al can preferably react automatically to any anomalies that occur.

The aforementioned memory device can be located within the machine or in a cloud. It is also possible to access data from other machines.

In a further advantageous embodiment, the apparatus has an assignment device which is suitable and intended for assigning to each plastics material preform inspected (and/or analyzed) (by the inspection device and/or the spectral analysis device) the production unit or the mold tool which has produced this plastics material preform.

Preferably, a clear position of the plastics material preforms in the removal device or in the take-off/picker makes it possible to assign the plastics material preform to the cavity of the mold or the production unit.

Preferably, it is possible to forward an evaluation and/or transfer of the recognized cavities or production units or mold tools to the control device of the production device, in order to recognize trends/evaluations and preferably also to visualize them.

The image recording device of the first inspection device can be pivoted (into place) in order to record the image(s). It would also be possible that the plastics material preforms are transported next to and/or above the first inspection device and/or a second inspection device described in more detail below.

In a further advantageous embodiment, the apparatus has an assignment device which is suitable and intended for assigning to each plastics material preform inspected (and/or analyzed) (by the inspection device and/or the spectral analysis device) the forming station which will form this plastics material preform into a plastics material container.

In a further advantageous embodiment, the production device has a control device. Preferably, this control device is suitable and intended to control the production units using at least one value characteristic of an inspection result of the inspection (and/or analysis) of the plastics material preforms with the first inspection device and/or the spectral analysis device.

Particularly preferably, the apparatus also has a control device for controlling the forming device, wherein this control device is suitable and intended for controlling each forming station separately and/or independently of other forming stations. Particularly preferably, this control device is suitable and intended for controlling the forming stations also as a function of a value which is obtained by inspecting (and/or analyzing) the plastics material preforms with the first inspection device and/or the first spectral analysis device and/or which is characteristic of an inspection result of an inspection (and/or analysis) of the plastics material preforms with the first inspection device and/or the first spectral analysis device.

Preferably, the first inspection device is suitable and intended for inspecting several plastics material preforms and/or for outputting at least one value for each of the inspected plastics material preforms, which value is characteristic of this individual plastics material preform.

Preferably, the first spectral analysis device is suitable and intended for inspecting (and/or analyzing) several plastics material preforms and/or for outputting at least one value for each of the inspected plastics material preforms, which value is characteristic of this individual plastics material preform.

For example, the inspection device can record an image of a plurality of plastics material preforms and from this image at least one value can be output for each individual one of this plurality of plastics material preforms, which is characteristic of this particular plastics material preform and/or the inspection of this particular plastics material preform.

In a further preferred embodiment, the inspection device has an evaluation device that is suitable and intended for evaluating the images recorded by the inspection device. Particularly preferably, this evaluation device is suitable and intended for individualizing individual plastics material preforms from an image recorded by the image recording device, which shows a plurality of plastics material preforms, and preferably also for determining values characteristic of these plastics material preforms.

In a further preferred embodiment, the spectral analysis device has an evaluation device which is suitable and intended for evaluating the spectra recorded by the spectral analysis device. Particularly preferably, this evaluation device is suitable and intended for drawing conclusions from a spectrum of a plastics material preform recorded by the spectral analysis device about a physical property of this plastics material preform and, in particular, about a material composition of the material of this plastics material preform.

In another advantageous embodiment, the transport device is suitable and intended for transporting the plastics material preforms singly from the production device to the forming device. Singly is understood to mean that the plastics material preforms are transported individually and therefore each individual plastics material preform can be customized. For example, this transport device can have at least one or preferably several transport wheels and/or transport chains. Preferably, the transport device is configured in such a way that a predefined sequence of the transported plastics material preforms is maintained.

Preferably, the spectral analysis device is arranged in an area in which the plastics material preforms are transported in series.

However, individual transport is also possible if the plastics material preforms are transported on a common carrier, but the individual plastics material preforms have a defined position in relation to one another, which is given for example by the shape of the carrier, for example if the carrier has a plurality of receiving means for holding individual plastics material preforms. Preferably, the transport device has at least one transport unit that transports the plastics material preforms in a single row. Preferably, the transport device has at least one transport unit that transports the plastics material preforms as an array, such as in particular the above-mentioned transport carrier that receives a plurality of plastics material preforms.

Non-individual transport occurs, for example, if a plurality of plastics material preforms are placed in a common receiving container, in which they are positioned arbitrarily relative to one another.

Due to this individualization, an assignment of individual inspected plastics material preforms to forming stations or production units is possible.

In a further advantageous embodiment, the transport device has a carrier suitable for the receptacle of a plurality of plastics material preforms.

Preferably, the transport device has a carrier that is suitable for receiving a plurality of plastics material preforms, in each case with the same alignment. Particularly preferably, the plastics material preforms are transported by the carrier in an alignment parallel to one another.

Particularly preferably, this carrier can be transported in two independent directions, in particular in two mutually perpendicular directions, as part of the transport device.

Preferably, the transport device has a removal device that is suitable and intended for picking up the plastics material preforms-preferably from the cooling device. Preferably, this removal device is also suitable and intended for picking up individual plastics material preforms and supplying them to a subsequent transport path. Furthermore, this removal device is preferably also suitable and intended for picking up individual plastics material preforms and/or discharging them from the transport path.

In a further advantageous embodiment, the apparatus has a second inspection device that is suitable and intended for inspecting the plastics material preforms and that is arranged between the cooling device and the forming device. Preferably, this second inspection device is also suitable for inspecting a predefined region of the plastics material preforms, wherein this predefined region is preferably different from the predefined region inspected by the first inspection device.

Preferably, this second inspection device is suitable and intended for inspecting the cooled plastics material preforms and/or for inspecting the plastics material preforms during and/or after their cooling.

In a further preferred embodiment, the apparatus has at least one illumination device that is suitable and intended for illuminating plastics material preforms inspected by the first inspection device and/or by the second inspection device. It is also possible that the plastics material preforms are positioned next to and/or below and/or above this illumination device, in order to inspect the plastics material preforms.

Preferably, this second inspection device is suitable and intended for inspecting a main body of the plastics material preforms.

Particularly preferably, this second inspection device has an image recording device that is suitable and intended for recording a spatially resolved image of a plurality of plastics material preforms.

Preferably, the apparatus has a further assignment device that is suitable and intended for assigning to each plastics material preform inspected by the second inspection device the production unit that has produced this plastics material preform.

In a further preferred embodiment, the apparatus has a further assignment device, which is suitable for assigning to each plastics material preform inspected by the second inspection device the forming station that will form this plastics material preform into a plastics material container.

Preferably, the above-mentioned control device for controlling the production device is suitable and intended for controlling the production units using at least one value that is characteristic of an inspection result of the inspection of the plastics material preforms with the second inspection device.

Particularly preferably, the above-mentioned control device for controlling the forming device is suitable and intended for controlling the forming stations also as a function of a value that is obtained by inspecting the plastics material preforms with the second inspection device and/or that is characteristic of an inspection result of an inspection of the plastics material preforms with the second inspection device.

Preferably, the second inspection device is suitable and intended for inspecting several plastics material preforms and/or for outputting at least one value for each of the inspected plastics material preforms, which value is characteristic of this individual plastics material preform.

For example, the second inspection device can record an image of a plurality of plastics material preforms and from this image at least one value can be output for each individual one of this plurality of plastics material preforms, which value is characteristic of this particular plastics material preform and/or the inspection of this particular plastics material preform.

In a further preferred embodiment, the second inspection device has an evaluation device that is suitable and intended for evaluating the images recorded by the inspection device. Particularly preferably, this evaluation device is suitable and intended for individualizing individual plastics material preforms from an image recorded by the image recording device, which image shows a plurality of plastics material preforms.

In this embodiment, it is provided that at least two inspection devices are present, which inspect the plastics material preforms. In this way, a relationship can also be established between the state of the plastics material preforms before and after cooling the plastics material preforms.

It is also possible that the two inspection devices inspect different regions of the plastics material preform(s). Preferably, the first inspection device inspects a mouth region of the plastics material preforms, while the second inspection device inspects a main body of the plastics material preforms. Preferably, the mouth region of the plastics material preforms is a region of the plastics material preforms that is not formed by the forming device, whereas the main body of the plastics material preforms is a region of the plastics material preforms that is formed and, in particular, expanded by the forming device.

In a further advantageous embodiment, at least one inspection device and preferably the first and second inspection device are suitable and intended for detecting at least one and preferably a plurality of values that are characteristic of physical properties of the plastics material preforms.

Particularly preferably, these properties are selected from a group of properties including a geometry of the plastics material preforms, a cross-section of the plastics material preforms, a length of the plastics material preforms, a color of the plastics material preforms, a transparency of the plastics material preforms, a moisture value of the plastics material preforms, an IV value (intrinsic viscosity) of the plastics material preforms, a temperature of the plastics material preforms, damage to the plastics material preforms and the like.

In a further preferred embodiment, at least one inspection device is suitable and intended for inspecting the plastics material preforms during their movement. Preferably, both the first and the second inspection device are suitable and intended for inspecting the plastics material preforms during their movement.

In a further preferred embodiment, at least one spectral analysis device is suitable and intended for inspecting and/or analyzing the plastics material preforms during their movement. Preferably, both the first and second spectral analysis devices are suitable and intended for inspecting and/or analyzing the plastics material preforms during their movement.

In a further advantageous embodiment, the apparatus has a heating device for heating the plastics material preforms produced by the production device. This heating device can be, for example, an infrared or microwave oven.

Particularly preferably, this heating device is arranged between the cooling device and the forming device. Particularly preferably, the heating device also has a transport device that transports the plastics material preforms individually. Furthermore, this heating device preferably also has a rotating device for rotating the plastics material preforms with respect to their axis during heating.

In a further advantageous embodiment, the apparatus has a discharge device that is suitable and intended for ejecting or discharging individual plastics material preforms from the transport path of the plastics material preforms between the production device and the forming device. Discharge is understood to mean that such plastics material preforms are no longer supplied to the forming process.

Particularly preferably, this discharge device is arranged downstream of the second inspection device and/or upstream of the forming device. Preferably, this rejection device is arranged downstream of the first spectral analysis device. Particularly preferably, this rejection device is suitable and intended for rejecting individual plastics material preforms in response to an inspection result of at least one of the inspection devices and/or one of the spectral analysis devices. However, it would also be conceivable that a third inspection device is provided and that the discharge device discharges individual plastics material preforms taking into account an inspection result from this third inspection device.

In a further advantageous embodiment, the apparatus has a gap-closing device that closes gaps created by the discharge of individual plastics material preforms. This gap-closing device can have a buffer that fills existing gaps.

In a further advantageous embodiment, the apparatus, and in particular the transport device, has a turning device that changes the alignment of transported plastics material preforms.

Preferably, the apparatus has a carrier on which a plurality of plastics material preforms can be arranged after their production, and the turning device is suitable and intended for turning the carrier with the plastics material preforms arranged thereon.

Preferably, this turning device is suitable and intended for turning the plastics material preforms by a predefined angle, preferably by 90°. Preferably, the turning device is suitable and intended for turning the plastics material preforms from a horizontal alignment (i.e., an alignment in which the longitudinal directions of the plastics material preforms run horizontally) to a perpendicular alignment (i.e., an alignment in which the longitudinal directions of the plastics material preforms are aligned perpendicularly or vertically).

Preferably, the first inspection device is suitable and intended for recording an image of the plastics material preforms in their horizontal alignment.

Preferably, the second inspection device is suitable and intended for recording an image of the plastics material preforms in their perpendicular alignment.

Preferably, the first spectral analysis device is suitable and intended to perform a spectral analysis of the plastics material preforms while they are perpendicularly oriented.

in a further advantageous embodiment, the apparatus has at least one vacuum holding apparatus that is suitable and intended for holding individual plastics material preforms on holding bodies using negative pressure.

Due to this vacuum holding device, it is possible to detach individual plastics material preforms from their carriers.

Particularly preferably, a vacuum device of this kind is assigned to each plastics material preform. Individual plastics material preforms can therefore be detached from their holding devices by removing the vacuum. Preferably, the vacuum device is suitable and intended for detaching individual but in particular specific plastics material preforms from their holders using at least one inspection result of an inspection device and/or using at least one analysis result of a spectral analysis device.

Preferably, this vacuum device is a component of the discharge device.

In a further advantageous embodiment, the apparatus has a third inspection device for inspecting the plastics material preforms, wherein this third inspection device is preferably arranged downstream of the second inspection device.

This third inspection device is particularly suitable and intended for detecting impurities in the plastics material preforms produced (for example, so-called black specs).

The present invention is further directed to a method for producing plastics material containers, wherein a production device produces plastics material preforms and a forming device forms the plastics material preforms produced by the production device into the plastics material containers, wherein the production device has a plurality of production units, which produce plastics material preforms, and the forming device has a plurality of forming stations, which (in each case) form the plastics material preforms into the plastics material containers, wherein preferably these forming stations are arranged on a movable and in particular rotatable carrier, and wherein a transport apparatus transports the plastics material preforms produced by the production device to the forming device.

Advantageously, the apparatus has a cooling device which cools the plastics material preforms produced by the production device at least in portions.

According to the invention, the apparatus has a first spectral analysis device which inspects and/or analyzes at least one area of the plastics material preforms produced by the production device, wherein this first spectral analysis device is preferably arranged between the production device and the forming device and wherein this first spectral analysis device performs a spectral analysis of the radiation impinging on it.

Preferably, a first inspection device records a spatially resolved image of a plurality and in particular of each of the transported plastics material preforms. In a preferred method, the plastics material preforms recorded by the image recording device are at least partially detected individually. Preferably, all plastics material preforms are detected individually.

Preferably, the first spectral analysis device records a plurality of values, wherein each of these values is characteristic of exactly one plastics material preform picked up by the inspection device.

Preferably, the first inspection device records an image of the plastics material preforms during a movement of the plastics material preforms.

In a further preferred method, at least one and preferably a plurality of plastics material preforms inspected and/or analyzed by the spectral analysis device are assigned to the production unit which produced this plastics material preform.

In a further preferred method, at least one plastics material preform inspected by the first inspection device and/or at least one plastics material preform inspected and/or analyzed by the spectral analysis device, preferably several plastics material preforms inspected by the first inspection device and/or several plastics material preforms inspected and/or analyzed by the spectral analysis device and preferably all plastics material preforms inspected by the first inspection device and/or all plastics material preforms inspected and/or analyzed by the spectral analysis device are each assigned those forming stations which will form this plastics material preform into a plastics material container.

Preferably, the transport of the plastics material preforms is carried out individually, at least in portions. Preferably, the plastics material preforms are transported at least in portions in series.

Particularly preferably, the plastics material preforms are transported at least in portions by a receiving carrier that is suitable for receiving a plurality of the plastics material preforms.

In a further preferred method, the plastics material preforms are reheated after their cooling. In particular, the main bodies of the plastics material preforms are heated so that these plastics material bottles can be formed.

### BRIEF DESCRIPTION OF THE DRAWINGS

Further advantages and embodiments can be seen in the accompanying drawings.

In the drawings:

FIG. 1 shows a roughly schematic representation of an apparatus according to the invention;

FIG. 2 shows a representation of a production device for producing plastics material preforms in a first view; and

FIG. 3 shows a further view of the production device shown in FIG. 2;

FIG. 4 shows a representation for illustrating the method according to the invention.

### DETAILED DESCRIPTION OF THE INVENTION

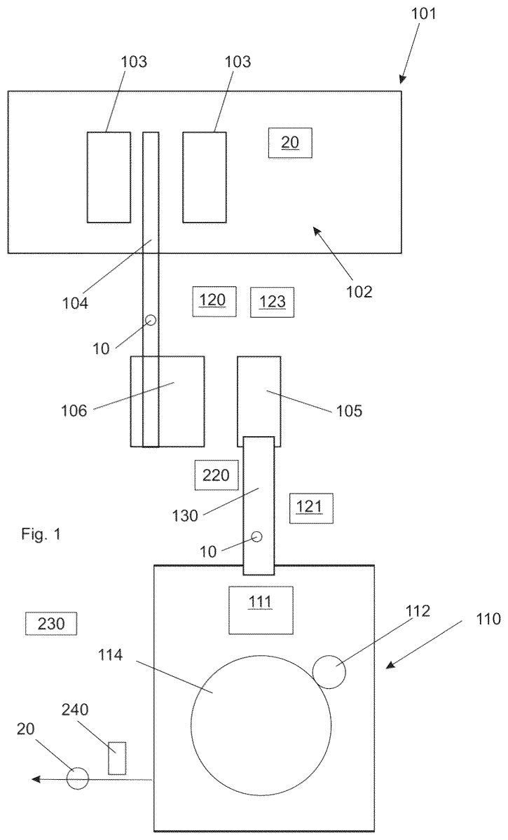

FIG. 1 shows a roughly schematic representation of an apparatus 101 for producing plastics material containers. This apparatus 101 has a production device 102 that produces plastics material preforms 10. Preferably, this production device 102 is an injection molding machine. This production device 102 has a plurality of production units 103 and, in particular, mold tools, which in each case are suitable and intended for producing individual plastics material preforms 10.

The reference sign 104 schematically designates a removal device that removes the injection-molded plastics material preforms 10 from the production units 103.

The reference sign 106 designates a cooling device, in particular in the form of a after-cooling unit, which cools the plastics material preforms 10 produced. Preferably, the plastics material preforms are inserted into this cooling device 106 and/or supplied to the cooling device directly after their production.

Preferably an inspection device and in particular a first temperature detection device 120 is arranged along the transport path of the transport device 104, which detects a temperature of the plastics material preforms or a value characteristic thereof and in particular detects it without contact. This first temperature detection device 120 is particularly suitable and intended for detecting the temperature of each individual plastics material preform 10. In addition to or instead of the temperature detection device, an inspection device can also be provided at this point, which detects at least one value characteristic of the plastics material preform.

The reference sign 123 designates an assignment device that assigns a production unit 103, which has produced this plastics material preform, to each plastics material preform 10 whose temperature has been detected. The production device 101 preferably has at least one control device that is suitable and intended for controlling the individual production units also as a function of the measured temperatures of the individual plastics material preforms.

The reference sign 105 designates a transport device and, in particular, a handling unit that picks up the plastics material preforms 10 from the transport device 104.

Additionally or alternatively, the assignment device 123 is also capable of assigning to each plastics material preform the forming station 112 which will form this plastics material preform into a plastics material container.

Preferably, therefore, the first inspection device and/or temperature detection device is arranged between the production device and/or the individual production units and the cooling device 106 and/or the transport device 105.

The reference sign 121 designates a further inspection device that detects at least one value that is characteristic of the particular inspected plastics material preform. Here as well, it can preferably be a value that is selected from a group of values that includes a geometry of the plastics material preforms, a color of the plastics material preforms, a moisture content of the plastics material preforms, an IV value of the plastics material preform, a temperature of the plastics material preform or the like.

The reference sign 220 schematically identifies a spectral analysis device provided according to the invention which is also suitable and intended for inspecting and, in particular, analyzing the individual plastics material preforms. In particular, a wavelength spectrum of radiation passing through the plastics material preforms is detected or recorded.

The reference sign 230 indicates a memory device in which a plurality of spectra for different plastics material preforms is preferably stored. If, for example, the spectra are recorded for a new group of plastics material preforms, it is possible to check whether they match a spectrum stored in the memory device 230.

Preferably, these values are made available to a higher-level control system in order to control parameters of the overall apparatus.

Furthermore, a discharge device can be provided, which (in particular depending on the characteristic values mentioned) has the effect that individual plastics material preforms are not transferred to the forming device 112. In this manner, plastics material preforms that have been assessed as defective on the basis of the analysis by the spectral analysis device can also be rejected.

Furthermore, a gap-closing device (not shown) can be provided, which closes any gaps created by the discharge of individual plastics material preforms.

The reference sign 110 designates in its entirety a forming device that forms the plastics material preforms into plastics material containers 20.

Initially, a heating device is preferably provided, which heats the plastics material preforms to a temperature that is suitable for forming and, in particular, expanding them into the plastics material containers 20.

The forming device 110 preferably has a rotatable carrier 114, on which a plurality of forming stations 112 are arranged. These forming stations are preferably controllable independently of one another.

The reference sign 240 identifies an optional second spectral analysis device that inspects and/or analyzes the plastics material containers 20 produced by the forming device 110.

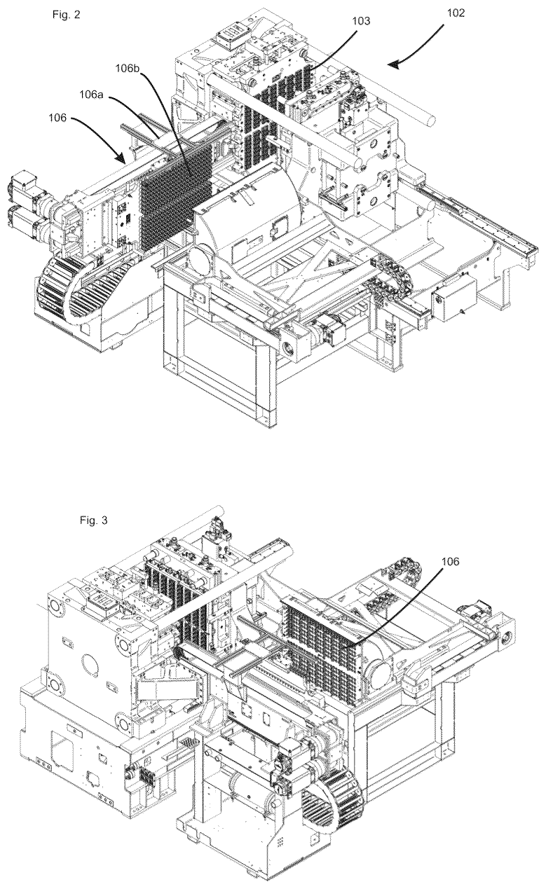

FIG. 2 and FIG. 3 show a first view of a production device 102 for producing the plastics material preforms. The reference sign 103 designates a plurality of production units, which in each case produce individual plastics material preforms.

The reference sign 106 designates a cooling device for cooling the plastics material preforms. The reference sign 106a designates a removal device for removing the plastics material preforms after the production process.

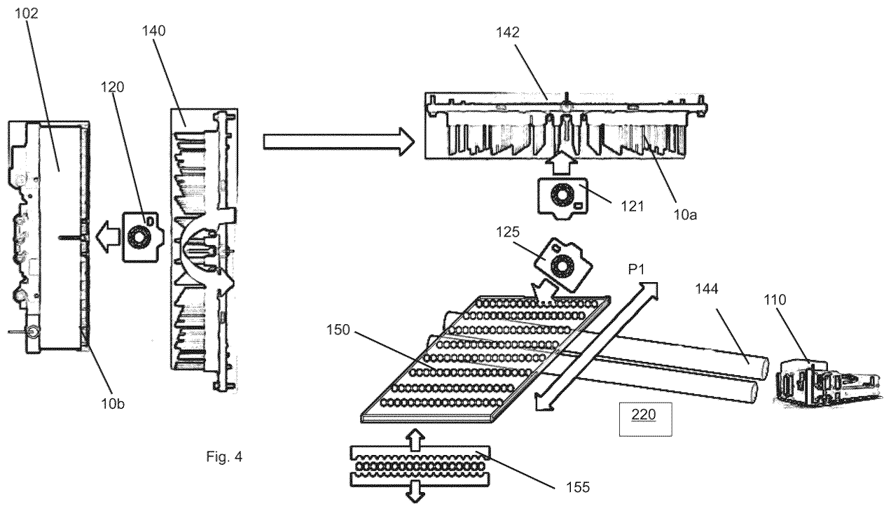

FIG. 4 shows a representation for illustrating the apparatus according to the invention and the method according to the invention.

Here, the production device 102 is provided, which has a plurality of production units (not shown in detail), each of which produces the plastics material preforms. The mouths 10b of the individual plastics material preforms can be recognized.

The reference sign 120 designates the first inspection device, which here in particular records an image of the mouths 10b, wherein the individual mouths and thus the individual plastics material preforms can be individualized. This also makes it possible to determine the production units that produced the plastics material preforms.

The reference sign 140 designates a turning device that turns the carrier with the plastics material preforms arranged thereon, in this case by 90°. In addition, the plastics material preform is cooled in this region by a cooling device (not shown here).

The turned carrier 142 is transported with the plastics material preforms arranged thereon and a second inspection device 121 records at least one image of the plastics material preforms, more precisely, now of the main bodies 10a of the plastics material preforms.

The reference sign 125 designates a third inspection device, which also inspects the plastics material preforms arranged in a carrier. Preferably, an inspection for material defects such as so-called black specs takes place here.

A vacuum holding device (not shown) is provided in the region of the carrier 142 and ensures that each individual plastics material preform is held on its own carrier. In this way, defective plastics material preforms can be separated from correct plastics material preforms.

In the embodiment shown in FIG. 4, defective plastics material preforms are initially still held by their (vacuum) grippers, while correct plastics material preforms are dropped onto a further transport unit 150.

From this further transport unit in the form of a carrier 150, the preforms can in turn be dropped onto a further transport unit 144, which in this case comprises two rollers arranged parallel to one another, between which the plastics material preforms 10 are guided. For this purpose, the carrier 150 with the individual plastics material preforms can be displaced along the arrow P1 relative to the further transport unit.

Strictly speaking, the carrier with the plastics material preforms is moved laterally over the transport unit 144. For this purpose, gaps 155 can open on the carrier, as shown at the bottom of FIG. 4, and the plastics material preforms can be dropped between the rollers.

The defective plastics material preforms, which are still held on the carrier 142 by vacuum grippers, can be ejected by selective control when the carrier 142 is retracted.

The reference sign 220 again indicates the first spectral analysis device, which is arranged here in the area of the above-mentioned rollers. In particular, this spectral analysis device can inspect or analyze the main bodies of the produced plastics material preforms.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for producing plastics material containers with a production device which is configured for producing plastics material preforms and with a forming device which is configured for forming the plastics material preforms into the plastics material containers, wherein the production device has a plurality of production units for producing the plastics material preforms and the forming device has a plurality of forming stations for forming the plastics material preforms into the plastics material containers, and with a transport device which is configured for transporting the plastics material preforms produced by the production device to the forming device,
wherein
the apparatus has a first spectral analysis device which is configured for inspecting and/or analyzing at least one area of the plastics material preforms produced by the production device, wherein said first spectral analysis device is arranged between the production device and the forming device, and wherein said first spectral analysis device is configured for spectrally analyzing the radiation impinging thereon.

2. The apparatus according to claim 1,
wherein
the first spectral analysis device is configured for detecting predetermined spectral areas of the radiation.

3. The apparatus according to claim 1,
wherein
the first spectral analysis device has a radiation device which is configured to irradiate the plastics material preforms and a radiation detector device which is configured for detecting radiation emitted by the radiation device and passing through the plastics material preforms.

4. The apparatus according to claim 1,
wherein
the apparatus has a second spectral analysis device which is configured for inspecting at least one area of the plastics material containers produced by the forming device.

5. The apparatus according to claim 1,
wherein
the apparatus has a memory device in which a plurality of spectral data characteristic of the plastics material preforms is stored.

6. The apparatus according to claim 1,
wherein
the apparatus has an assignment device that is configured for assigning to each inspected plastics material preform the production unit that has produced this plastics material preform and/or the apparatus has an assignment device that is configured for assigning to each inspected plastics material preform the forming station that will form this plastics material preform into a plastics material container.

7. The apparatus according to claim 1,
wherein
the apparatus has a control device for controlling the production device, wherein this control device is configured for controlling the production device and/or the apparatus has a control device for controlling the forming device, wherein this control device is configured for controlling the forming device of the plastics material preforms.

8. The apparatus according to claim 1,
wherein
the apparatus has a first inspection device which is configured for inspecting at least one area of the plastics material preforms produced by the production device, wherein this first inspection device has an image recording device which is configured for recording a spatially resolved image of a plurality of plastics material preforms.

9. The apparatus according to claim 1,
wherein
the transport device is configured for transporting the plastics material preforms individually from the production device to the forming device.

10. The apparatus according to claim 1,
wherein
the apparatus has a cooling device which is configured for cooling the plastics material preforms produced by the production device.

11. The apparatus according to claim 1,
wherein
at least the first or a second spectral analysis device is configured for determining at least one value which is characteristic of physical properties of the plastics material preforms.

12. The apparatus according to claim 1,
wherein
the apparatus has a heating device for heating the plastics material preforms produced by the production device.

13. The apparatus according to claim 1,
wherein
the apparatus has a discharge device that is configured for ejecting individual plastics material preforms from the transport path between the production device and the forming device.

14. A method for producing plastics material containers, wherein a production device produces plastics material preforms and a forming device forms the plastics material preforms produced by the production device into the plastics material containers, wherein the production device has a plurality of production units which produce the plastics material preforms and the forming device has a plurality of forming stations which form the plastics material preforms into the plastics material containers, and wherein a transport device transports the plastics material preforms produced by the production device to the forming device,
wherein
the apparatus has a first spectral analysis device which inspects and/or analyzes at least one area of the plastics material preforms produced by the production device, wherein said first spectral analysis device is arranged between the production device and the forming device, and wherein said first spectral analysis device performs a spectral analysis of the radiation impinging thereon.

15. The method according to claim 14,
wherein
at least one plastics material preform inspected and/or analyzed by the first spectral analysis device is assigned the production unit which has produced this plastics material preform and/or at least one plastics material preform inspected and/or analyzed by the first spectral analysis device is assigned the forming station which will form this plastics material preform into a plastics material container.
